(19) United States
(12) Patent Application Publication
(10) Pub. No.: US 2025/0042007 A1
(43) Pub. Date: Feb. 6, 2025

(54) LOCKING MEMBER FOR ADJUSTABLE TORQUE WRENCH

(71) Applicant: Apex Brands, Inc., Apex, NC (US)

(72) Inventor: Kevin William Myhill, Lexington, SC (US)

(21) Appl. No.: 18/792,435

(22) Filed: Aug. 1, 2024

Related U.S. Application Data
(60) Provisional application No. 63/530,793, filed on Aug. 4, 2023.

(51) Int. Cl. B25B 23/142

(52) U.S. Cl. CPC B25B 23/1427

(57) ABSTRACT

A torque wrench may include a head having a driving member configured to be operably coupled to a socket, a handle, a lever arm operably coupled to the head and the handle at respective opposing ends thereof, a torque adjuster configured to enable a torque setting of the torque wrench to be adjusted and an adjustment channel which may be disposed between the handle and the torque adjuster. A locking member may be disposed within the adjustment channel to block the torque adjuster from changing the torque setting.

### TECHNICAL FIELD

Example embodiments generally relate to hand tools and, in particular, relate to a locking member for an adjustable torque wrench.

### BACKGROUND

Hand tools are commonly used across all aspects of industry and in the homes and workshops of consumers. Hand tools are employed for multiple applications including, for example, fastener tightening, component joining, and/or the like. For some fastener tightening applications, a highly accurate torque setting is either preferred or required. To provide the ability to accurately apply torque, a class of hand tools referred to generally as torque wrenches have been developed. Torque wrenches are calibrated devices that enable the operator to know when a particular torque is reached. The means by which the operator is informed of the fact that the particular torque has been reached can vary with corresponding different types of torque wrenches.

For one particular type of torque wrench, an audible and/or tactile “click” is generated to inform the operator that the particular torque has been reached. In many cases, a spring extends through the lever arm of the torque wrench to apply pressure to a ball that interfaces with the ratchet head of the torque wrench. Until the particular torque is reached, the ball is retained (by the force of the spring) in a socket or depression that enables torque to be applied along the lever arm of the torque wrench and through the ratchet head. However, when the particular torque is reached, the spring force on the ball is overcome, and the ball is allowed to slip out of the socket in which it was retained, and into another socket, thereby providing the audible and/or tactile “click” to let the operator know that the particular torque has been reached. Torque wrenches of this type often provide the operator with the ability to select the particular torque via an adjuster that is provided on the handle of the torque wrench. Often, the operator turns the handle relative to the lever arm to adjust the tension setting of the spring inside the lever arm.

However, this particular type of torque wrench may not often be used in manufacturing operations due to how easily the torque setting can be adjusted. In this regard, a torque wrench that can be adjusted too easily may affect the quality of the manufacturing assembly. Thus, it may be desirable to provide a cost effective solution to prevent any attempt to tamper with the torque setting of an adjustable torque wrench.

### BRIEF SUMMARY OF SOME EXAMPLES

Some example embodiments may enable the provision of an improved interface for the adjuster and/or an improved handle that facilitates optimal positioning of the hand of the operator.

In an example embodiment, a torque wrench may be provided. The torque wrench may include a head having a driving member configured to be operably coupled to a socket, a handle, a lever arm operably coupled to the head and the handle at respective opposing ends thereof, a torque adjuster configured to enable a torque setting of the torque wrench to be adjusted and an adjustment channel which may be disposed between the handle and the torque adjuster. A locking member may be disposed within the adjustment channel to block the torque adjuster from changing the torque setting.

In another example embodiment, a locking member for an adjustable torque wrench may be provided. The locking member may prohibit the adjustable torque wrench from changing a torque setting by blocking a torque adjuster of the adjustable torque wrench. The locking member may be disposed within an adjustment channel of the torque wrench that may be disposed between a handle and the torque adjuster. The locking member may be permanently operably coupled to the adjustable torque wrench.

### BRIEF DESCRIPTION OF THE SEVERAL VIEWS OF THE DRAWING(S)

Having thus described some example embodiments in general terms, reference will now be made to the accompanying drawings, which are not necessarily drawn to scale, and wherein:

FIG. 1 illustrates a perspective view of a torque wrench according to an example embodiment;

FIG. 2 illustrates a front view of the torque wrench of FIG. 1 according to an example embodiment;

FIG. 3 illustrates a rear view of the torque wrench of FIG. 1 according to an example embodiment;

FIG. 4 illustrates a close-up, front view of a torque adjuster of the torque wrench of FIG. 1 according to an example embodiment; and

FIG. 5 illustrates a perspective view of a locking member for the torque wrench according to an example embodiment.

### DETAILED DESCRIPTION

Some example embodiments now will be described more fully hereinafter with reference to the accompanying drawings, in which some, but not all example embodiments are shown. Indeed, the examples described and pictured herein should not be construed as being limiting as to the scope, applicability or configuration of the present disclosure. Rather, these example embodiments are provided so that this disclosure will satisfy applicable legal requirements. Like reference numerals refer to like elements throughout. Furthermore, as used herein, the term “or” is to be interpreted as a logical operator that results in true whenever one or more of its operands are true. As used herein, operable coupling should be understood to relate to direct or indirect connection that, in either case, enables functional interconnection of components that are operably coupled to each other.

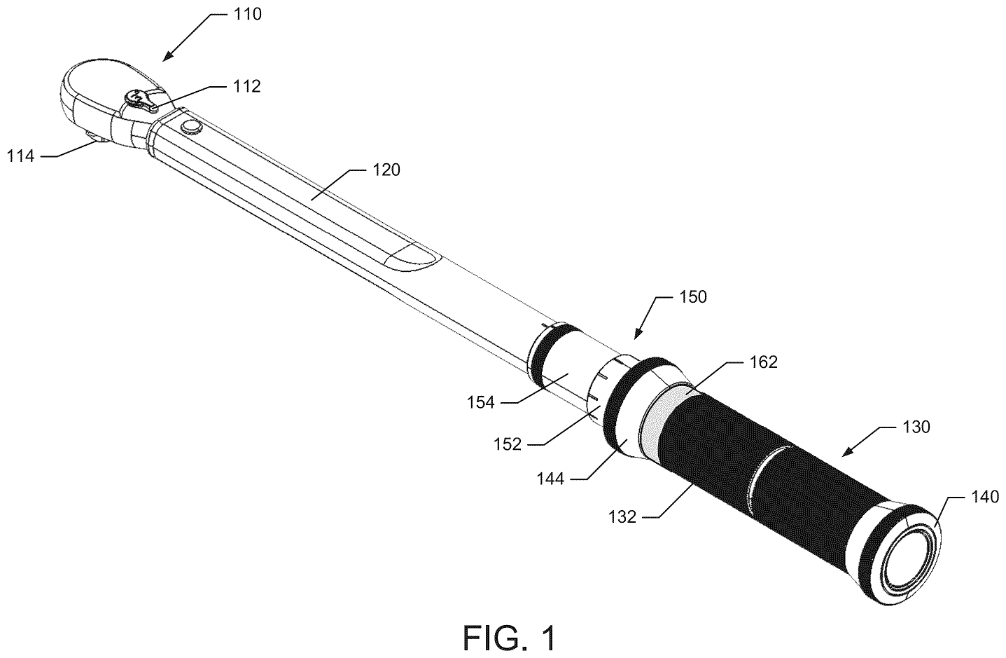

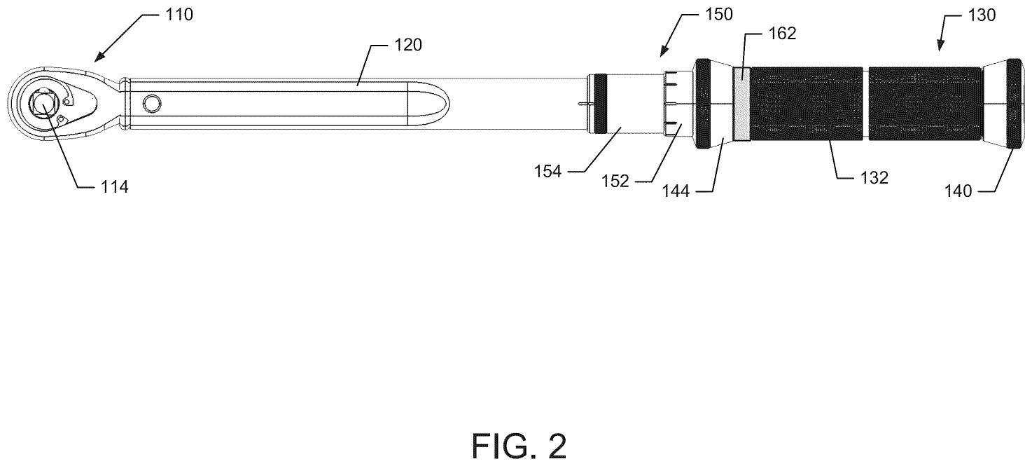

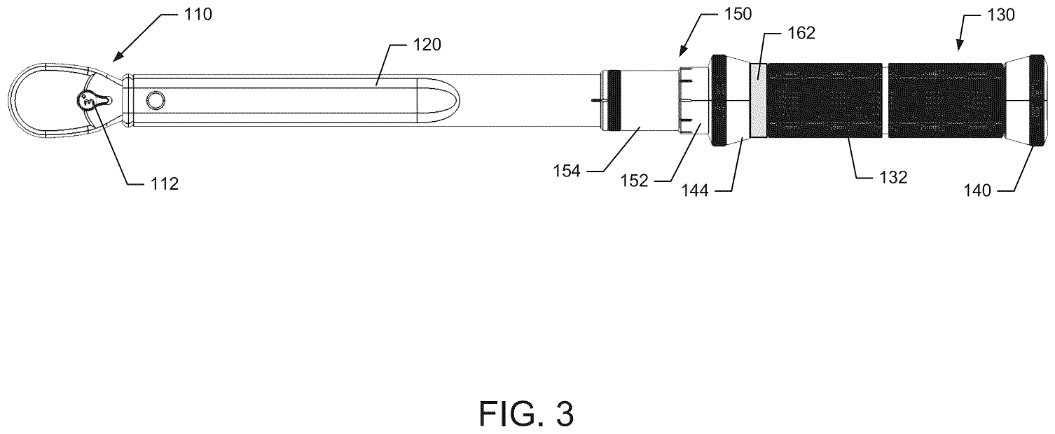

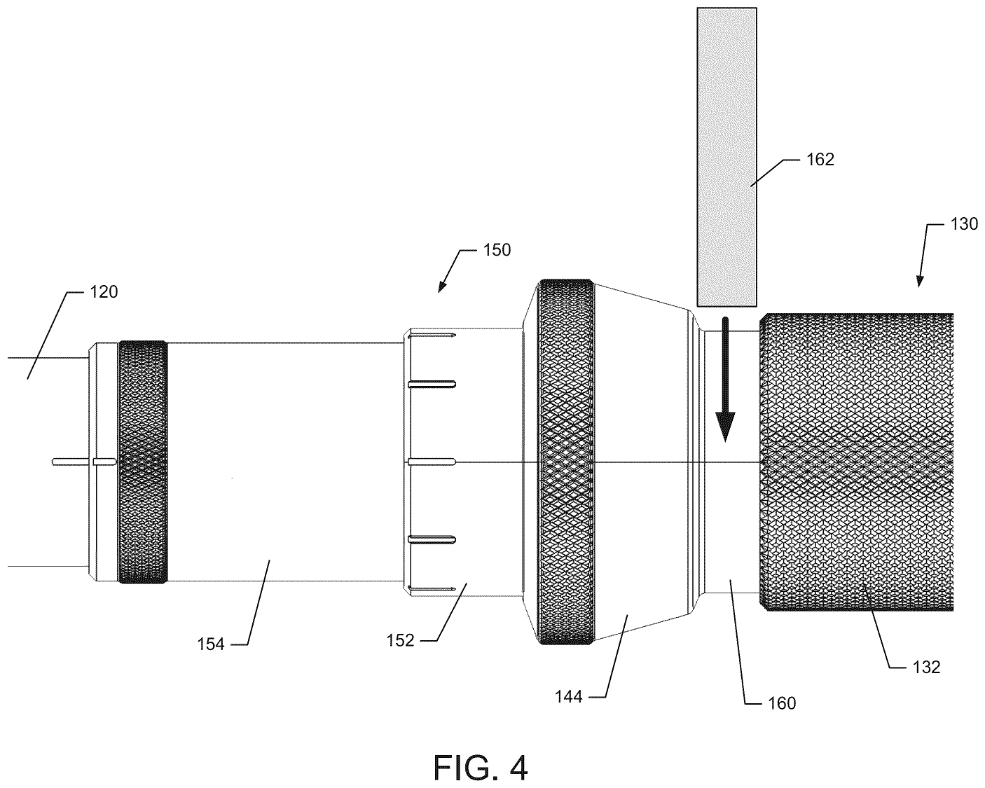

As indicated above, some example embodiments may relate to improvements to the design of a torque wrench 100. FIGS. 1-5 show various views or portions of one such example embodiment. In this regard, FIGS. 1-3 illustrate different views of a hand tool (e.g., the torque wrench 100) according to an example embodiment. As shown in FIGS. 1-3, the torque wrench 100 may include a head 110 (e.g., a ratchet head) that may include a direction selector 112 and a driving member 114. The direction selector 112 may be used to select which direction torque can be applied versus which direction torque is not applied and ratcheting is enabled. The driving member 114 may interface with a selected socket that may actually interface with the fastener that is being torqued. Various internal components of the head 110 may control the ratcheting capability, and may be outside the scope of this disclosure. However, it should also be appreciated that example embodiments could be practiced in a context in which ratcheting is either not desired or not enabled.

The head 110 may be operably coupled to a first end of a lever arm 120. A second end of the lever arm 120 may be operably coupled to a handle assembly or handle 130 of the torque wrench 100. The head 110 may have a substantially flat profile on both front and back faces thereof. Meanwhile, the lever arm 120 may maintain a width and flat profile that substantially matches that of the head 110 as the lever arm 120 extends away from the head 110 to improve accessibility of the head 110 and lever arm 120 into certain locations or proximate to potential obstructions. The lever arm 120 may further include a transition from the flat profile to a round (or substantially round) profile as the handle 130 is approached. The handle 130 may include a grip portion 132. The grip portion 132 may be made of aluminum or some other material that may have, for example, a knurled outer periphery that enhances the ability of the operator to grip the handle 130 effectively. The grip portion 132 may be disposed over a handle rod that may extend from an end cap 140 of the torque wrench 100 to a collar 144. The end cap 140 may be disposed at a distal end of the torque wrench 100 relative to the head 110, and the collar 144 may be disposed between the handle 130 and the lever arm 120. In an example embodiment, each of the end cap 140 and the collar 144 may have a diameter that is larger than the diameter of other portions of the handle 130 (e.g., including the grip portion 132).

Also shown in FIGS. 1-4, a torque adjuster 150 of an example embodiment may be located between the handle 130 and the lever arm 120. The adjuster 150 may include a movable member 152 and a fixed member 154 that may be operably coupled to each other. Meanwhile, the fixed member 154 may also be operably coupled to the lever arm 120. The movable member 152 and the fixed member 154 may each be substantially cylindrical in shape, with hollow centers. In an example embodiment, the movable member 152 may have an internal periphery that is slightly larger in diameter than a diameter of the external periphery of the fixed member 154 to allow the movable member 152 to rotate around at least a portion of the fixed member 154. The fixed member 154 may have an internal periphery that is slightly larger in diameter than a diameter of an external periphery of a distal end of the lever arm 120 relative to the head 110. This may enable the fixed member 154 to be slid over (and affixed to) the distal end of the lever arm 120.

In some cases, the collar 144 may also be a component of the adjuster 150, and may be used to alternately lock and unlock the adjuster 150 (e.g., by locking and unlocking the movable member 152 to prevent movement thereof). In this regard, the collar 144 may be moved axially between a locked position proximate to the movable member 152 and an unlocked position proximate to the grip portion 132 of the handle 130. When the collar 144 is in the locked position, movement of the movable member 152 may be prohibited. When the collar 144 is in the unlocked position, movement of the movable member 152 may be permitted. In an example embodiment, the collar 144 may be biased into the locked position to reduce the likelihood of unintentional movement of the movable member 152. With the collar 144 in the locked position, the collar may be spaced apart from the grip portion 132 by an adjustment channel 160. The adjustment channel 160 may extend radially around a perimeter of the torque wrench 100, and may be defined by the collar 144, the grip portion 132 and the handle rod of the torque wrench. The adjustment channel 160 may be the space into which the collar 144 may move to occupy the unlocked position. In other words, the adjustment channel 160 may be variable in size. It may be at a largest size with the collar 144 in the locked position, and it may shrink as the collar 144 enters the unlocked position. The adjustment channel 160 may disappear altogether responsive to the collar 144 coming into contact with the grip portion 132 in the unlocked position. In such cases, the collar 144 may be movable by a user of the torque wrench 100 against the direction of bias, into the unlocked position, and to occupy the adjustment channel 160. The collar 144 may thus be held in the unlocked position by the user while adjusting the torque setting via rotation of the movable member 152. In other embodiments, the collar 144 may not be biased at all. In this regard, the collar 144 may move between the locked and unlocked positions responsive to any external force, cither from the user of the torque wrench 100 or otherwise. In any case, the collar 144 may be moved away from the movable member 152 and into the unlocked position to permit rotational movement of the movable member 152. The movable member 152 may be operably coupled to the spring that is within the lever arm 120, and such movement of the movable member 152 may correspondingly adjust the tension of the spring. In this regard, by rotating the movable member 152, an adjustable screw may move within the lever arm 120 to adjust tension that the spring places on the ball to attempt to keep the ball in the socket as described above.

The fixed member 154 may have one or more sets of reference marks corresponding to respective values of torque in corresponding units of torque. These reference marks may become aligned with respective different incremental markings disposed around the external periphery of the movable member 152 responsive to rotation of the movable member 152. In some cases, the reference marks on the fixed member 154 may include increments of ten units and the incremental markings disposed around the external periphery of the movable member 152 may be ten increments of a single unit each (e.g., from 0 to 9). Thus, for example, if the 0 incremental marking on the movable member 152 is aligned with the reference marking for 50 units (e.g., lb-ft), then one complete rotation of the movable member 152 may cause the 0 incremental marking on the movable member 152 to align with the reference marking for either 40 units or 60 units (depending on the direction of rotation). Other relationships between the reference marks and the incremental markings may also be defined depending on the range and configuration of the torque wrench 100. Responsive to the adjustment of the torque setting via rotation of the movable member 152, the collar 144 may move from the unlocked position to the locked position, either via the biasing force or the force from the user, to secure the torque setting and prepare the torque wrench 100 for use.

In general, torque wrenches may be useful in many settings and scenarios where a user may need to know when a particular fastener has reached a desired torque value to avoid over-torqueing the fastener. For many cases, adjustable torque wrenches, such as the torque wrench 100 described herein, may be simpler and more cost effective to use. However, there may be some cases in which adjustable torque wrenches may be less desirable than other forms of torque wrenches. For instance, in a manufacturing setting, there may be a plurality of workers stationed along an assembly line each using a torque wrench having the torque setting curated to their particular role in the assembly. In other words, the torque wrench of a single worker may be used to torque a same fastener to a same torque rating repeatedly, on each iteration of the object being manufactured. In such cases, since the torque setting of the torque wrenches may not need to be changed that frequently, an adjustable torque wrench may not only be unnecessary, but also a potential hindrance to both the quality and efficiency of the assembly.

For example, it may often be the case that the torque setting is adjusted at a portion just forward of the grip portion 132. Thus, for a conventional design torque wrench 100, the potential misplacement of the operator's hand could either change the torque setting or at the very least, unlock the torque adjuster. In other words, adjustable torque wrenches may be easily tampered with, both intentionally and unintentionally, by a user or anyone else who may come in contact with the torque wrench. If an adjustable torque wrench 100 were to have its torque setting changed without the user being aware of the change, then the fasteners torqued down by said torque wrench 100 may be at an improper torque specification for the particular assembly. For this reason, a “preset” torque wrench, or a plurality of preset torque wrenches, may often be used in manufacturing and assembly settings. Preset torque wrenches may require a unique tool and a torque calibration device to change the torque. Thus, while their torque setting may still be adjusted, the process for changing the torque may not be as simple for preset torque wrenches as it may be for adjustable torque wrenches. While using preset torque wrenches does not impose an inherent problem for the manufacturing setting, preset torque wrenches may be more expensive to use in a manufacturing setting because of the need to supply more of them for the different torqueing applications, in addition to the added equipment and preparation they may require. Thus, it may be desirable to provide a more cost efficient and simpler alternative to preset torque wrenches that allows adjustable torque wrenches to be more tamper resistant to maintain quality in the assembly.

Therefore, in order to make the torque wrench 100 “tamper proof” and prevent the torque setting of the torque wrench 100 from being adjusted, the torque wrench 100 of the embodiments shown in FIGS. 1-5 may further include a locking member 162. In some cases, the locking member 162 may be disposed in the adjustment channel 160, which may be disposed between the handle 130 and the torque adjuster 150, and more particularly, between the grip portion 132 and the collar 144. Simply put, the locking member 162 may prohibit the torque adjuster 150 from changing the torque setting by limiting a range of motion of the torque adjuster 150 and blocking the collar 144 from entering the adjustment channel 160. In this regard, the locking member 162 may be disposed substantially in the adjustment channel 160 between the collar 144 and the grip portion 132, that may otherwise be occupied by the collar 144 when in the unlocked position. Thus, the locking member 162 may block the collar 144 from sliding into the unlocked position, therefore preventing the collar 144 from unlocking the movable member 152 accordingly.

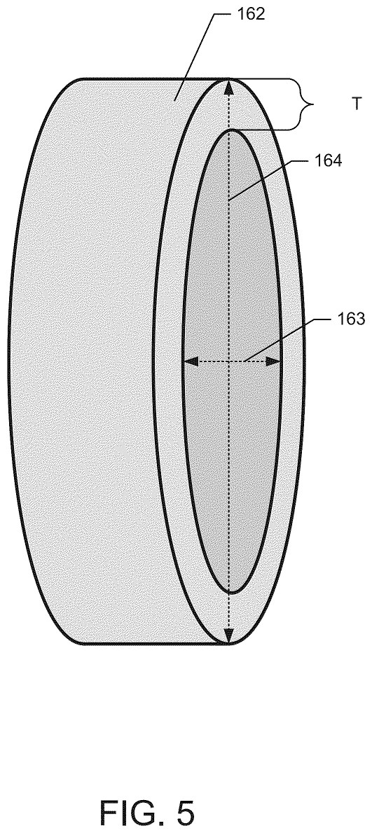

As shown in FIG. 5, the locking member 162 of some embodiments may be substantially annular in shape. An inner diameter 163 of the locking member 162 may be slightly larger in diameter than an outer diameter of the adjustment channel 160 to which the locking member 162 may operably couple. This may enable the locking member 162 to operably couple to the torque wrench 100 between the collar 144 and the grip portion 132. The locking member 162 may have a thickness (T) that may be substantially equal to a depth of the adjustment channel 160, defined as the distance between the holding rod and an outermost surface of the grip portion 132. As such, the outer diameter 164 of the locking member 162 may be approximately the same as an outer diameter of the grip portion 132 so that the locking member 162 may be substantially flush with the grip portion 132. In some cases, the locking member 162 may be made from a plastic material. In some other cases, the locking member 162 may simply be a filling made from an epoxy and formed to the particular dimensions of the adjustment channel 160.

In some cases, the locking member 162 may be permanently operably coupled to the torque wrench 100. In this regard, the locking member 162 may be operably coupled to the adjustment channel 160 via an adhesive or via some form of a self-locking means where once the locking member 162 is installed, it cannot be undone. For example, in an example embodiment, the locking member 162 may be a heat shrunk wrap and may be disposed in the adjustment channel 160, and in some cases, around at least a portion of the handle 130 and at least a portion of the torque adjuster 150 (e.g. the collar 144). In such an embodiment, the locking member 162 may prevent movement of the collar 144 into the unlocked position by occupying the adjustment channel 160. In any case, with the locking member 162 being permanently operably coupled to the torque wrench 100, the locking member 162 may need to be removed from the torque wrench 100 to adjust the torque setting of the torque wrench 100 via the torque adjuster 150. In order to remove the locking member 162 from the torque wrench 100, the locking member 162 may need to be broken, hence how the torque wrench 100 is made tamper-proof by the locking member 162. Any efforts to tamper with the torque setting of the torque wrench 100 may require the locking member 162 to be removed and therefore to be broken in order to be removed. Thus, a user of the torque wrench 100 may be able to tell right away if the torque setting has been changed by whether or not the locking member 162 has been broken and removed. In the example of the heat shrunk wrap locking member 162, the locking member may need to be cut and peeled off of the torque wrench 100 to allow the adjustment of the torque setting accordingly. In any case, after being broken and removed from the torque wrench 100, the locking member 162 may not be reinstalled onto the torque wrench 100. However, in some cases, a different locking member 162 may be installed onto the torque wrench 100 after the torque setting has been changed to a desired amount to fix the torque setting.

In an example embodiment, the locking member 162 may be included on the torque wrench 100 from the point of purchase. As such, the locking member 162 may be installed during a manufacturing process of the torque wrench 100 and may thus be included with the torque wrench 100. In some other cases, the locking member 162 may be made available for purchase on its own, allowing the user of the torque wrench 100 to accordingly fix the torque setting of the torque wrench 100 after removing any locking member 162 and adjusting the torque setting. In some cases, the locking member 162 may be manufactured and distributed in various sizes for potential use on different torque wrenches as well. In some cases, the locking member 162 may be annular in shape. However, in some other cases, the locking member 162 may be other shapes as well. In this regard, the locking member 162 may be substantially C-shaped or any other shape that may occupy the adjustment channel 160 and prevent motion of the collar 144 into the adjustment channel 160 accordingly.

As can be appreciated from the example of FIGS. 1-5, example embodiments may define a hand tool (i.e., a torque wrench) with various unique features. The torque wrench may include a head having a driving member configured to be operably coupled to a socket, a handle, a lever arm operably coupled to the head and the handle at respective opposing ends thereof, a torque adjuster configured to enable a torque setting of the torque wrench to be adjusted and an adjustment channel which may be disposed between the handle and the torque adjuster. A locking member may be disposed within the adjustment channel to block the torque adjuster from changing the torque setting.

The torque wrench and/or its components may include a number of modifications, augmentations, or optional additions, some of which are described herein. These modifications, augmentations or optional additions may be included in any combination. For example, the torque adjuster may include a collar slidable between an unlocked position, in which the torque setting may be adjustable, and a locked position, in which the torque setting may be fixed. In some cases, the locking member may block the collar from sliding into the unlocked position. In an example embodiment, the locking member may be permanently operably coupled to the torque wrench. In some cases, the locking member may be removed from the torque wrench to change the torque setting via the torque adjuster. In an example embodiment, the locking member may be broken to be removed from the torque wrench. In some cases, the locking member may not be reinstalled onto the torque wrench after being removed. In an example embodiment, the locking member may include a plastic material. In some cases, the locking member may include an epoxy. In an example embodiment, the locking member may be a heat shrunk wrap and may be disposed around at least a portion of the handle and at least a portion of the torque adjuster. In some cases, the locking member may be annular in shape.

Some example embodiments may provide for a locking member for an adjustable torque wrench. The locking member may prohibit the adjustable torque wrench from changing a torque setting by blocking a torque adjuster of the adjustable torque wrench. The locking member may be disposed within an adjustment channel of the torque wrench that may be disposed between a handle and the torque adjuster. The locking member may be permanently operably coupled to the adjustable torque wrench.

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Moreover, although the foregoing descriptions and the associated drawings describe exemplary embodiments in the context of certain exemplary combinations of elements and/or functions, it should be appreciated that different combinations of elements and/or functions may be provided by alternative embodiments without departing from the scope of the appended claims. In this regard, for example, different combinations of elements and/or functions than those explicitly described above are also contemplated as may be set forth in some of the appended claims. In cases where advantages, benefits or solutions to problems are described herein, it should be appreciated that such advantages, benefits and/or solutions may be applicable to some example embodiments, but not necessarily all example embodiments. Thus, any advantages, benefits or solutions described herein should not be thought of as being critical, required or essential to all embodiments or to that which is claimed herein. Although specific terms are employed herein, they are used in a generic and descriptive sense only and not for purposes of limitation.

What is claimed is:

1. A torque wrench comprising:
a head including a driving member configured to be operably coupled to a socket;
a handle;
a lever arm operably coupled to the head and the handle at respective opposing ends thereof;
a torque adjuster configured to enable a torque setting of the torque wrench to be adjusted; and
an adjustment channel disposed between the handle and the torque adjuster,
wherein a locking member is disposed within the adjustment channel to block the torque adjuster from changing the torque setting.

2. The torque wrench of claim 1, wherein the torque adjuster comprises a collar slidable between an unlocked position, in which the torque setting is adjustable, and a locked position, in which the torque setting is fixed.

3. The torque wrench of claim 2, wherein the locking member blocks the collar from sliding into the unlocked position.

4. The torque wrench of claim 1, wherein the locking member is permanently operably coupled to the torque wrench.

5. The torque wrench of claim 4, wherein the locking member must be removed from the torque wrench to change the torque setting via the torque adjuster.

6. The torque wrench of claim 5, wherein the locking member must be broken to be removed from the torque wrench.

7. The torque wrench of claim 6, wherein the locking member cannot be reinstalled onto the torque wrench after being removed.

8. The torque wrench of claim 1, wherein the locking member is comprised of a plastic material.

9. The torque wrench of claim 1, wherein the locking member is comprised of an epoxy.

10. The torque wrench of claim 1, wherein the locking member is a heat shrunk wrap disposed around at least a portion of the handle and at least a portion of the torque adjuster.

11. A locking member for an adjustable torque wrench, wherein the locking member prohibits the adjustable torque wrench from changing a torque setting by blocking a torque adjuster of the adjustable torque wrench,
wherein the locking member is disposed within an adjustment channel of the torque wrench that is disposed between a handle and the torque adjuster, and
wherein the locking member is permanently operably coupled to the adjustable torque wrench.

12. The locking member of claim 11, wherein the torque adjuster comprises a collar slidable between an unlocked position, in which the torque setting is adjustable, and a locked position, in which the torque setting is fixed.

13. The locking member of claim 12, wherein the locking member blocks the collar from sliding into the unlocked position.

14. The locking member of claim 11, wherein the locking member must be removed from the torque wrench to change the torque setting via the torque adjuster.

15. The locking member of claim 14, wherein the locking member must be broken to be removed from the torque wrench.

16. The locking member of claim 15, wherein the locking member cannot be reinstalled onto the torque wrench after being removed.

17. The locking member of claim 11, wherein the locking member is comprised of a plastic material.

18. The locking member of claim 11, wherein the locking member is comprised of an epoxy.

19. The locking member of claim 11, wherein the locking member is a heat shrunk wrap disposed around at least a portion of the handle and at least a portion of the torque adjuster.

20. The locking member of claim 11, wherein the locking member is annular in shape.
